(19) United States
(12) Patent Application Publication
(10) Pub. No.: US 2025/0225568 A1
(43) Pub. Date: Jul. 10, 2025

(54) CONTEXT FOR FULFILLMENT TRANSACTIONS

(71) Applicant: Motorola Mobility LLC, Chicago, IL (US)

(72) Inventors: Krishnan Raghavan, Bangalore (IN); Rahul Sahadevan, Bengaluru (IN); Nakul Patel, Bangalore (IN)

(73) Assignee: Motorola Mobility LLC, Chicago, IL (US)

(21) Appl. No.: 18/404,012

(22) Filed: Jan. 4, 2024

(51) Int. Cl. G06Q 30/0601

(52) U.S. Cl. CPC G06Q 30/0635; G06Q 30/0641

(57) ABSTRACT

Techniques for context for fulfillment transactions are described and are implementable to enable context information for fulfillment transactions to be stored, presented, and filtered.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without challenges. For instance, financial transactions can be associated with multiple types of context information that can be difficult and/or infeasible to track over time.

Further, the prevalence of network-based fulfilment transaction systems (such as online shopping and marketplace services) has become ubiquitous worldwide. Users now engage in a myriad of transactions within these network-based platforms, accessible through various devices, including portable ones like smartphones. While the convenience of online shopping and marketplace applications is undeniable, it comes with its set of challenges. Similar to finance systems, transactions in the online shopping realm are intricately linked with diverse contextual information, presenting difficulties in tracking and managing this information over time.

### BRIEF DESCRIPTION OF THE DRAWINGS

Aspects of context for fulfillment transactions are described with reference to the following Figures. The same numbers may be used throughout to reference similar features and components shown in the Figures. Further, identical numbers followed by different letters reference different instances of features and components described herein.

FIG. 1 illustrates an example environment in which aspects of context for fulfillment transactions can be implemented.

FIG. 2 depicts aspects of an example system for context for fulfillment transactions in accordance with one or more implementations.

FIG. 3 depicts aspects of an example system for context for fulfillment transactions in accordance with one or more implementations.

FIG. 4 depicts a scenario including an example implementation of the fulfillment GUI in accordance with one or more implementations.

FIG. 5 depicts a scenario including an example implementation of the fulfillment GUI in accordance with one or more implementations.

FIG. 6 depicts a scenario including an example implementation of the fulfillment GUI in accordance with one or more implementations.

FIG. 7 depicts a scenario including an example implementation of the fulfillment GUI in accordance with one or more implementations.

FIG. 8a depicts a scenario including an example implementation of the fulfillment GUI in accordance with one or more implementations.

FIG. 8b depicts a scenario including an example implementation of the fulfillment GUI in accordance with one or more implementations.

FIG. 9 depicts a scenario including an example implementation of the fulfillment GUI in accordance with one or more implementations.

FIG. 10 depicts a scenario including an example implementation of the fulfillment GUI in accordance with one or more implementations.

FIG. 11 depicts a scenario including an example implementation of the fulfillment GUI in accordance with one or more implementations.

FIG. 12 depicts a scenario including a contacts GUI in accordance with one or more implementations.

FIG. 13 illustrates a flow chart depicting an example method for context for fulfillment transactions in accordance with one or more implementations.

FIG. 14 illustrates a flow chart depicting an example method for context for fulfillment transactions in accordance with one or more implementations.

FIG. 15 illustrates a flow chart depicting an example method for context for fulfillment transactions in accordance with one or more implementations.

FIG. 16 illustrates a flow chart depicting an example method for context for fulfillment transactions in accordance with one or more implementations.

FIG. 17 illustrates a flow chart depicting an example method for context for fulfillment transactions in accordance with one or more implementations.

FIG. 18 illustrates a flow chart depicting an example method for context for fulfillment transactions in accordance with one or more implementations.

FIG. 19 illustrates a flow chart depicting an example method for context for fulfillment transactions in accordance with one or more implementations.

FIG. 20 illustrates a flow chart depicting an example method for context for fulfillment transactions in accordance with one or more implementations.

FIG. 21 illustrates a flow chart depicting an example method for context for fulfillment transactions in accordance with one or more implementations.

FIG. 22 illustrates various components of an example device in which aspects of context for fulfillment transactions can be implemented.

### DETAILED DESCRIPTION

Techniques for context for fulfillment transactions are described and are implementable to enable transaction user to specify different types of context information for fulfillment transactions, e.g., purchase transactions performed via interaction between a fulfillment application and a fulfillment service.

For instance, consider a scenario where a user engages in a fulfillment transaction with a transaction service to purchase a gift for a friend's birthday party. The user has the gift delivered to the user's home with the intent to deliver the gift in person. Thus, a transaction record for the fulfillment transaction may reflect that the gift was delivered to the user but may not provide any additional context for the gift, e.g., why the gift was purchased, for whom the gift was purchased, etc. Upon later attempting to purchase a gift for the friend the user may be forget the previous purchase and be uncertain as which gift to purchase for the friend and may inadvertently purchase the same gift, causing unnecessary time and expense to return the duplicative gift and purchase a new gift. Thus, a fulfilment transaction can refer to a retail-oriented ecommerce purchase, where an individual consumer acquires goods or services for personal use, extending to purchases made for oneself, friends, family, as gifts, etc.

Accordingly, techniques described herein enable users to provide different types of transaction context for fulfillment transactions. In implementations a fulfillment transaction represents a digital transaction that involves the generation and transmission of different types of data. For instance, fulfillment transactions involve generating, transmitting, and processing various types of data across a variety of different systems and networks. Thus, such fulfillment transactions can be characterized as sets of computational operations much like other operations of a computing device and/or set of computing devices. Accordingly, by enabling users to provide context information for fulfillment transactions and for the context information to be converted into context data associated with the fulfillment transactions, the described techniques can conserve user and system resources (e.g., memory, processor bandwidth, network bandwidth, etc.) that may otherwise be used to manually filter through fulfillment transaction history and/or correct mistaken fulfillment transactions, and thus the described techniques can improve the operation of computing devices and data networks, and improve productivity of the user.

While features and concepts of context for fulfillment transactions can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

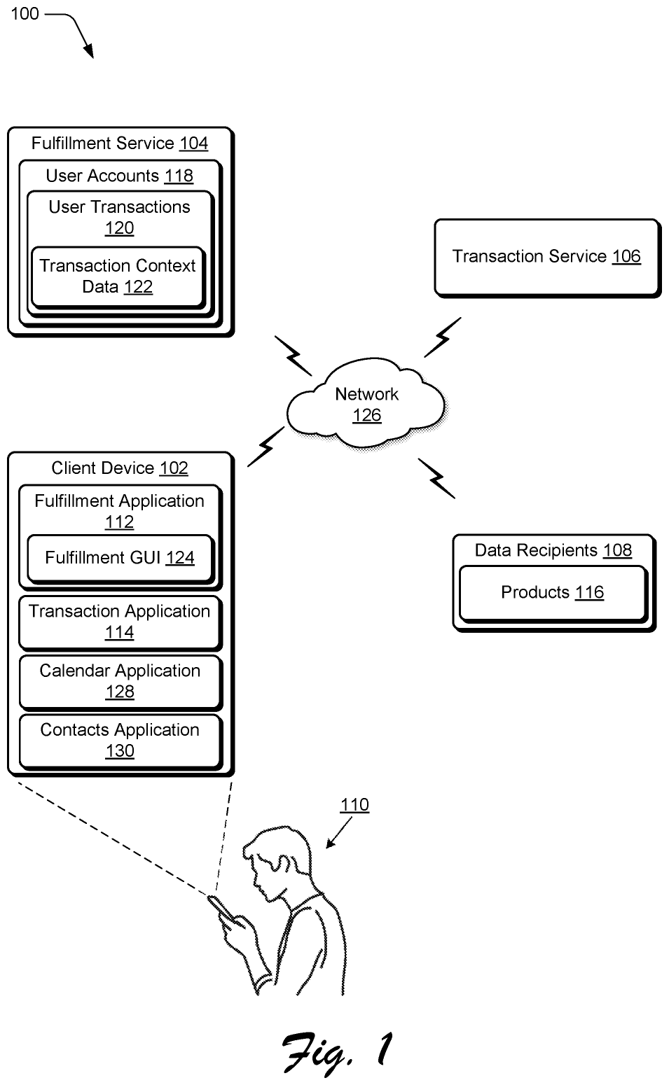

FIG. 1 illustrates an example environment 100 in which aspects of context for fulfillment transactions can be implemented. The environment 100 includes a client device 102, a fulfillment service 104, a transaction service 106, and data recipients 108. The client device 102 represents a device that can be used by a user 110 to perform and manage different transactions. Transactions, for instance, include fulfillment transactions, e.g., data transactions such as for purchasing goods and services. Examples of the client device 102 include mobile devices such as mobile phones, wearable devices, extended reality (XR) devices, tablets, laptops, etc. The client device 102, however, may be implemented in other ways, such as a desktop computing device, a server device, etc.

The client device 102 includes different functionalities that enable aspects of context for fulfillment transactions including a fulfillment application 112 and a transaction application 114. The fulfillment application 112 represents an application that enables a user 110 of the client device 102 to engage in different fulfillment transactions, such as purchases of products, e.g., goods and/or services. The fulfillment application 112, for example, can interface with fulfillment service 104 to perform fulfillment transactions. In implementations the fulfillment service 104 represents a network-based service that is accessible to the client device 102 such as via the fulfillment application 112 to enable the user 110 of the client device 102 to engage in different fulfillment transactions.

The transaction application 114 represents functionality for enabling the client device 102 to engage in different data transactions, such as managing the transfer of different types of data. In at least one example the transaction service 106 facilitates the transfer of data representing value (e.g., monetary and/or other types of value) as part of facilitating fulfillment transactions between the fulfillment application 112 of the client device 102 and the fulfillment service 104.

The transaction service 106 can be implemented by various entities, such as a banking entity, a payment service, an enterprise entity, a trading entity, a data storage and/or management entity, and/or combinations thereof. The user 110, for instance, can utilize a transaction application 114 on the client device 102 to access the transaction service 106 to perform different finance transactions, such as to transfer value amounts (e.g., monetary values) for different purposes, e.g., to purchase goods and services. The transaction application 114, for example, represents functionality that enables various finance-related transactions to be performed via the client device 102, including access to the transaction service 106.

The data recipients 108 represent entities with which the client device 102 may engage in fulfillment transactions and/or data transactions. For instance, the user 110 can utilize the fulfillment application 112 to engage in a fulfillment transaction (e.g., a purchase of goods and/or services) with a data recipient 108 and which is facilitated by the fulfillment service 104. Further, an exchange of data (e.g., data representing value) as part of the fulfillment transaction can be enabled via the transaction service 106.

For example, the data recipients 108 via the fulfillment service 104 can provide products 116 (e.g., goods and/or services) to the user 110 and in exchange the client device 102 can cause a transfer of data via the transaction service 106 (e.g., data representing an exchange of value) to the data recipients 108. In at least one implementation the data exchange between the client device 102 and the data recipients 108 is facilitated (e.g., managed) by the transaction service 106. The transaction service 106, for example, can implement a transfer of data (e.g., a data representation of value such as monetary value) to the data recipients 108 on behalf of the client device 102.

The fulfillment service 104 includes data and/or functionality for implementing various aspects of context for fulfillment transactions including user accounts 118, user transactions 120, and transaction context data 122. The user accounts 118, for instance, include various identification data and behavior data for different user interactions with the fulfillment service 104, and include a user account 118 for the user 110. The user transactions 120 track different fulfillment transactions for the various user accounts 118. Further, the transaction context data 122 tracks different transaction context information for different instances of the user transactions 120. Examples of the transaction context data 122 are described throughout this disclosure an include information such as occasions or purpose of purchase associated with user transactions 120 (e.g., birthdays, weddings, graduations, holiday celebrations, etc.), persons associated with user transactions 120 (e.g., identifiers for persons for which a product was purchase), context notes provided by a user regarding user transactions 120, and so forth.

The fulfillment application 112 is configured to present a fulfillment graphical user interface (GUI) 124 on the client device 102 which is operable to receive user input to engage in fulfillment transactions (e.g., user transactions 120) with the fulfillment service 104 as well as to receive user input to specify different transaction context data 122. Further, when the user 110 interacts with the fulfillment application 112 such as part of a shopping interaction, the fulfillment GUI 124 can present historical user transactions 120 and transaction context data 122 associated with the user transactions 120, such as to enable the user 110 to make more informed decisions regarding fulfillment transactions.

The client device 102 further includes other applications that operable to implement aspects discussed herein including a calendar application 128 and a contacts application 130. As further detailed below, for instance, the calendar application 128 and the contacts application 130 can be implemented to present transaction context data 122 for fulfillment transactions.

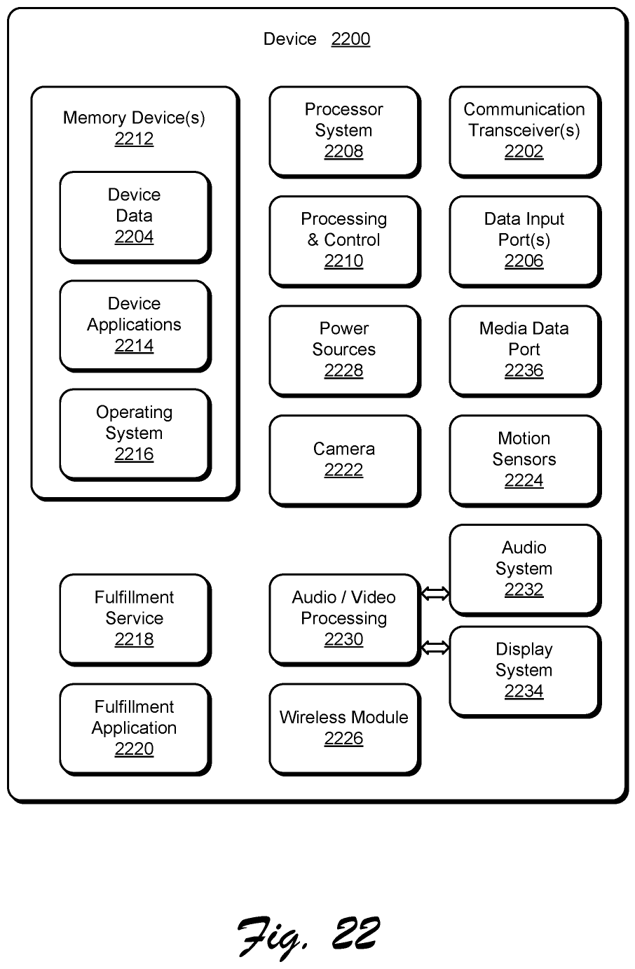

The client device 102, the fulfillment service 104, the transaction service 106, and/or the data recipients 108 can be implemented in various ways and include various functionality, examples of which are discussed below with reference to the example device 2200 of FIG. 22. Further, various entities of the environment 100 can be connected and communicate via a network 126. The network 126, for example, can represent a combination of wired and wireless networks via which the client device 102, the fulfillment service 104, the transaction service 106, and/or the data recipients 108 can participate in various types of communication, such as wired and/or wireless data communication.

Having discussed an example environment in which the disclosed techniques can be performed, consider now some example scenarios and implementation details for implementing the disclosed techniques.

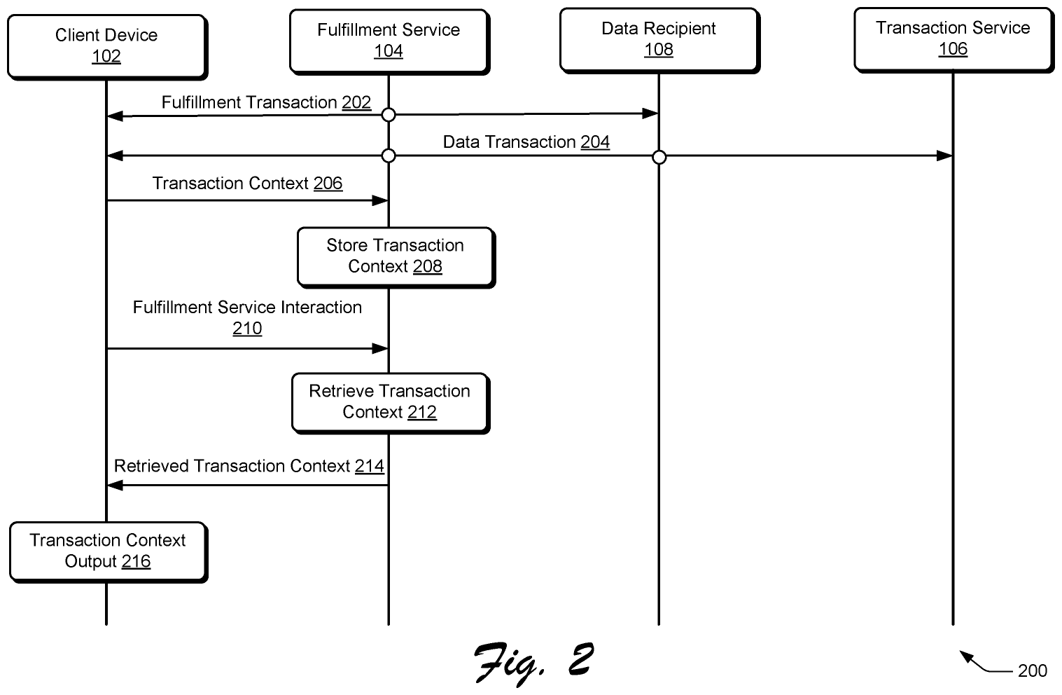

FIG. 2 depicts aspects of an example system 200 for context for fulfillment transactions in accordance with one or more implementations. The system 200 can be implemented in the environment 100 and incorporates attributes of the environment 100 introduced above.

In the system 200, the client device 102 engages in a fulfillment transaction 202 with a data recipient 108. The fulfillment transaction 202 can represent various types of data-based transactions, such as an exchange of data, a purchase transaction (e.g., a purchase of a product), and combinations thereof. In at least one implementation the fulfillment transaction 202 involves a provision of a product 116 by the data recipient 108 to the user 110 of the client device 102.

Further to the system 200, the fulfillment transaction 202 is implemented via the fulfillment service 104. The fulfillment service 104, for instance, represents a network-based portal via which different fulfillment transactions can be performed. Further, in conjunction with the fulfillment transaction 202, a data transaction 204 is implemented via the transaction service 106. For instance, the client device 102, the fulfillment service 104, the data recipient 108, and the transaction service 106 participate in the data transaction 204 which involves a transfer of data (e.g., data representing value) from the transaction service 106 to the data recipient 108. For example, in the context of a finance transaction and as part of the data transaction 204, the transaction service 106 transfers a data representation of value (e.g., monetary value, digital currency, etc.) on behalf of the client device 102 to the data recipient 108. In some embodiments, the data transaction 204 can be decoupled from the fulfillment transaction 202 and can be executed subsequent to the physical fulfillment of the transaction. For example, the fulfillment transaction 202, which entails the online purchase of a product using payment methods such as Cash on Delivery (COD), involves the data transaction 204 (transfer of monetary funds to data recipient or a representative of data recipient) occurring upon the successful completion of the physical fulfillment of the transaction, e.g., the delivery of the purchased product.

In conjunction with the fulfillment transaction 202 the user 110 provides transaction context 206 regarding the fulfillment transaction 202 via the client device 102. Examples of the transaction context 206 are described throughout this disclosure, such as with reference to the transaction context data 122. At 208 the fulfillment service 104 stores the transaction context 206, such as part of the transaction context data 122.

Further to the system 200 the user 110 interacts with the client device 102 via the fulfillment application 112 to perform a fulfillment service interaction 210 with the fulfillment service 104. The fulfillment service interaction 210, for instance, occurs after the fulfillment transaction 202 and after the transaction context is stored at 208. In at least one implementation the fulfillment service interaction 210 represents a shopping experience with the fulfillment service 104. Accordingly, in conjunction with the fulfillment service interaction 210, at 212 the fulfillment service 104 retrieves transaction context. The fulfillment service 104, for instance, locates a user account 118 for the user 110 and retrieves transaction context data 122 for the user account 118. Accordingly, the fulfillment service 104 transmits retrieved transaction context 214 to the client device 102 and at 216 the client device 102 performs transaction context output. The fulfillment application 112, for instance, outputs the retrieved transaction context 214 as part of the fulfillment GUI 124, such as in conjunction with the fulfillment service interaction 210.

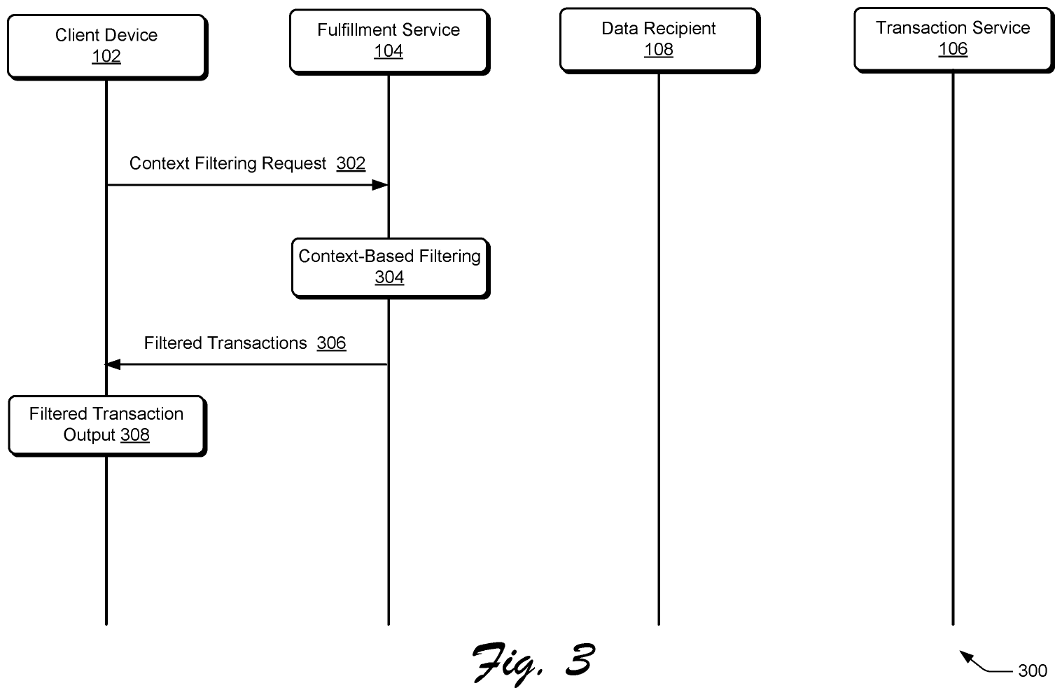

FIG. 3 depicts aspects of an example system 300 for context for fulfillment transactions in accordance with one or more implementations. The system 300 can be implemented in the environment 100 and incorporates attributes of the environment 100 introduced above. In at least some implementations the system 300 represents a continuation of the system 200.

In the system 300 a context filtering request 302 is transmitted to the fulfillment service 104. The context filtering request 302, for instance, requests that user transactions and/or available products be filtered and presented based on transaction context. The context filtering request 302 can be initiated in various ways, such as via express user input to the fulfillment application 112 to request context filtering. As another example the context filtering request 302 can be automatically generated and transmitted by the fulfillment application 112, such as based on a user interaction with the fulfillment GUI 124, e.g., a shopping interaction.

As another example, the user 110 can initiate a gift purchase from a calendar notice of an event (e.g., a birthday, a holiday party, etc.), such as from a calendar notice presented in a calendar application and/or the fulfillment application 112. In response to the initiated gift purchase the fulfillment application 112 can be launched and event participants identified in the calendar notice (e.g., persons other than the user 110) can be used to generate the context filtering request 302. For instance, the context filtering request 302 can include identifiers for the event participants and the context filtering request 302 can request that products previously purchased for the event participants be filtered out of products presented as purchase options for the event participants and/or the calendar event. Alternatively or additionally the context filtering request 302 can request that products previously purchased for the event participants be flagged as previously purchased for one or more of the event participants.

As another example, the user 110 can initiate a product purchase from a user contacts entry for a particular contact. In response to the initiated gift purchase the fulfillment application 112 can be launched and a contact identifier for the contact can be used to generate the context filtering request 302. For instance, the context filtering request 302 can include the contact identifier and the context filtering request 302 can request that products previously purchased for the contact be filtered out of products presented as purchase options for the contact. Alternatively or additionally the context filtering request 302 can request that products previously purchased for the contact be flagged as previously purchased for the contact.

Further to the system 300 the fulfillment service 104 receives the context filtering request 302 and performs context-based filtering 304 based on different transaction context data 122, examples of which are described above. The context-based filtering 304, for instance, can identify (e.g., flag) products that match transaction context specified in the context filtering request 302. Alternatively or additionally the context-based filtering 304 can filter out (e.g., remove) products that match transaction context specified in the context filtering request 302.

Based on the context-based filtering 304 that fulfillment service 104 transmits filtered transactions 306 to the client device 102 and the client device 102 performs filtered transaction output 308 to output at least some of the filtered transactions 306, such as via the fulfillment GUI 124. The filtered transaction output 308, for example, can flag products that correlate to the context filtering request 302 and/or can exclude or only include products that correlate to the context filtering request 302.

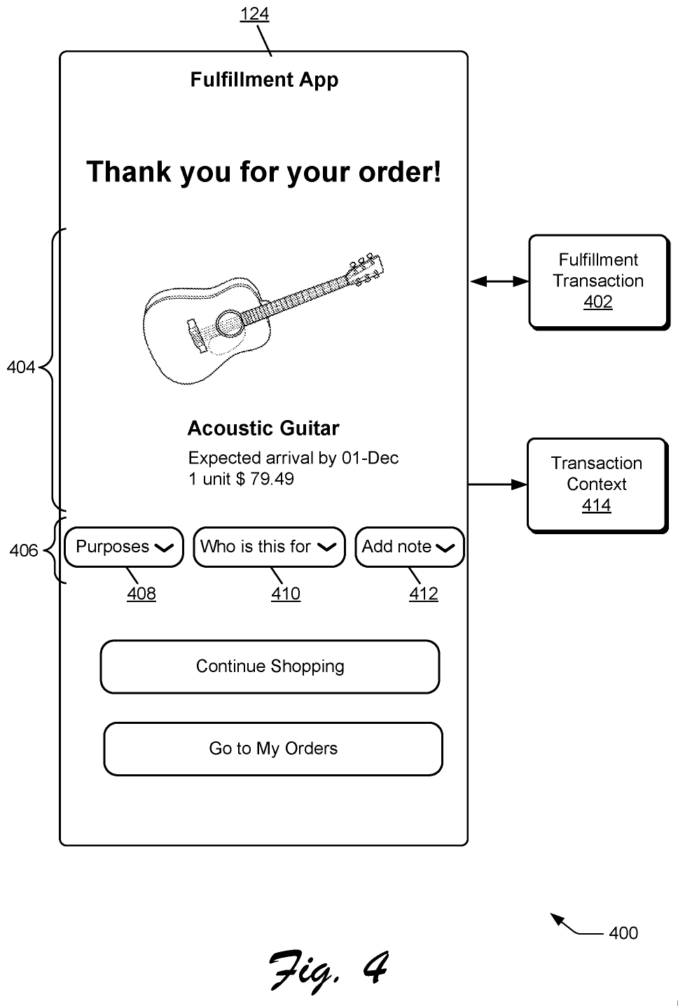

FIG. 4 depicts a scenario 400 including an example implementation of the fulfillment GUI 124 in accordance with one or more implementations. The fulfillment GUI 124, for instance, is presented via the client device 102 and enables a user to interact with the fulfillment service 104 in various ways.

In this particular example the fulfillment GUI 124 indicates that a fulfillment transaction 402 has occurred. Accordingly, the fulfillment GUI 124 includes a transaction details region 404 and transaction context options 406. The transaction details region 404 includes details for the fulfillment transaction 402, such as a product purchased, an expected arrival time of the product, a price for the product, etc. The transaction context options 406 include different context options for providing transaction context for the fulfillment transaction 402, including a purposes option 408, a recipient option 410, and a notes option 412. As further detailed below each of the transaction context options 406 are selectable to enable the user 110 to provide transaction context 414 for the fulfillment transaction 402.

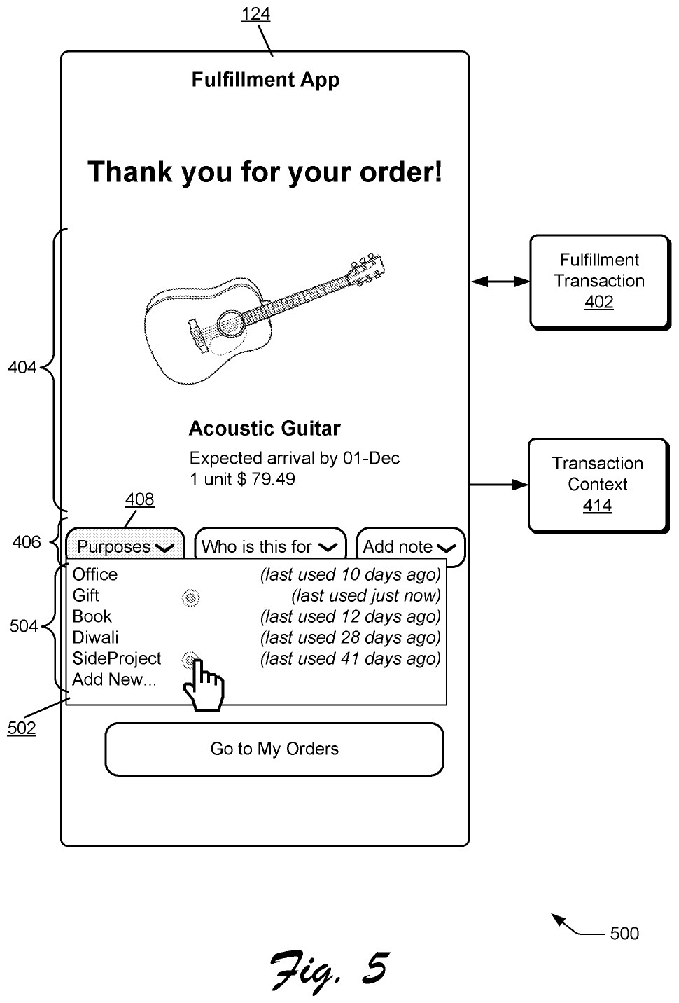

FIG. 5 depicts a scenario 500 including an example implementation of the fulfillment GUI 124 in accordance with one or more implementations. The scenario 500, for instance, represents a continuation of the scenario 400. In the scenario 500 the user 110 selects the purposes option 408 and a purpose menu 502 is presented that includes different selectable purpose options 504 for the fulfillment transaction 402, e.g., “Office,” “Gift,” “Book,” etc. Further, each of the purpose options 504 includes a history indicator specifying when the particular purpose option was most recently selected. In the scenario 500 the user 110 selects the “Gift” and “SideProject” purpose options 504 which are used to generate at least a part of the transaction context 414. Further, purpose menu 502 also provides user 110 an option to create and add a new purpose.

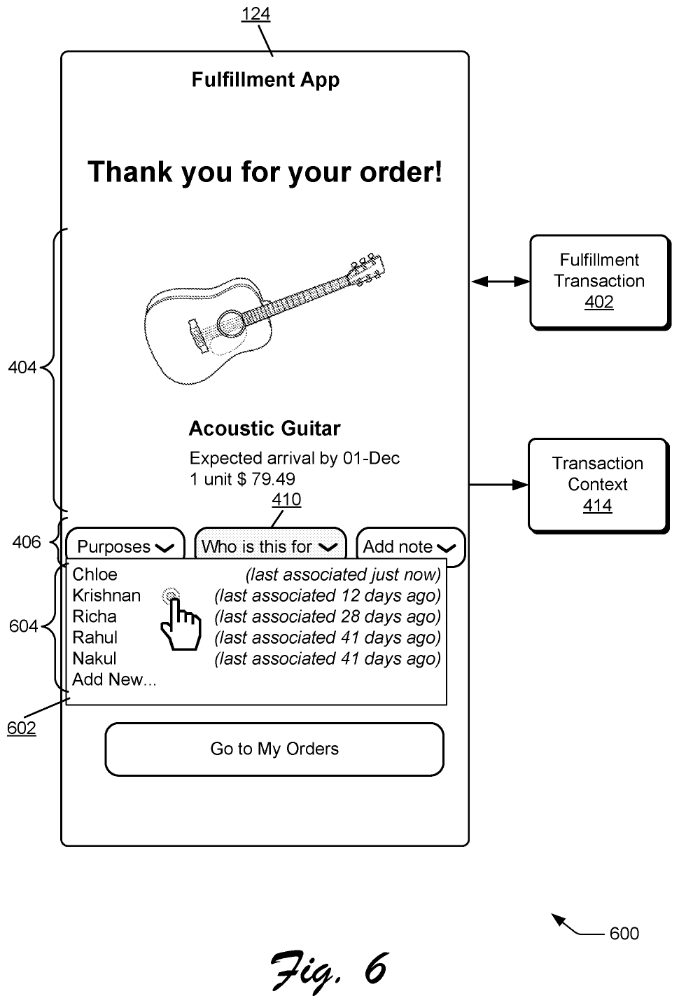

FIG. 6 depicts a scenario 600 including an example implementation of the fulfillment GUI 124 in accordance with one or more implementations. The scenario 600, for instance, represents a continuation of the scenarios 400, 500. In the scenario 600 the user 110 selects the recipient option 410 and a recipient menu 602 is presented that includes different recipient identifiers 604 for potential recipients of the purchased product. The recipient identifiers 604, for instance, can be based on recipients historically identified via the fulfillment application 112 as recipients of purchased products and/or can represented identifiers for contacts extracted from a contacts list of the user 110. Further, each of the recipient identifiers 604 includes a history indicator indicating when a respective recipient was most recently indicated as a product recipient. Further, recipient menu 602 also provides user 110 an option to create and add a new recipient.

In the scenario 600 the user 110 selects the recipient “Krishnan” as a recipient of the purchased products. Accordingly the transaction context 414 is updated to indicate Krishnan as a recipient. Note that while a single recipient is indicated in this example, implementations can enable multiple recipients to be associated with an instance of a fulfillment transaction.

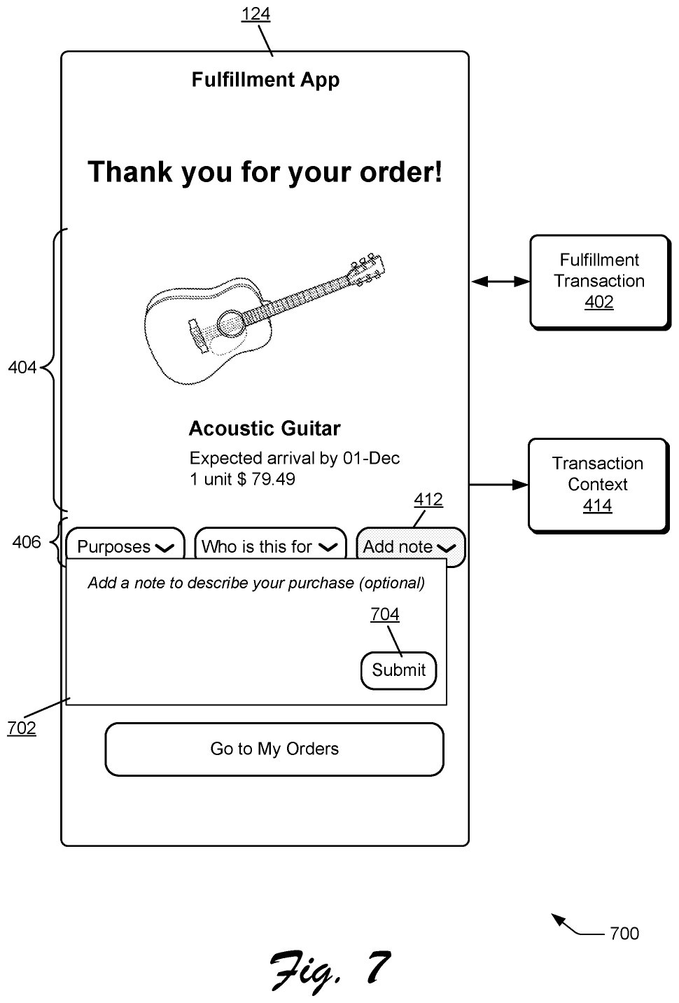

FIG. 7 depicts a scenario 700 including an example implementation of the fulfillment GUI 124 in accordance with one or more implementations. The scenario 700, for instance, represents a continuation of the scenarios 400-600. In the scenario 700 the user 110 selects the notes option 412 and a notes field 702 is presented that enables the user 110 to provide additional context on the fulfillment transaction 402. The notes field 702 indicates that providing input to the notes field 702 is optional. A submit control 704 is presented that is selectable to submit input to notes field 702 as part of the transaction context options 406 as the transaction context 414 for the fulfillment transaction 402.

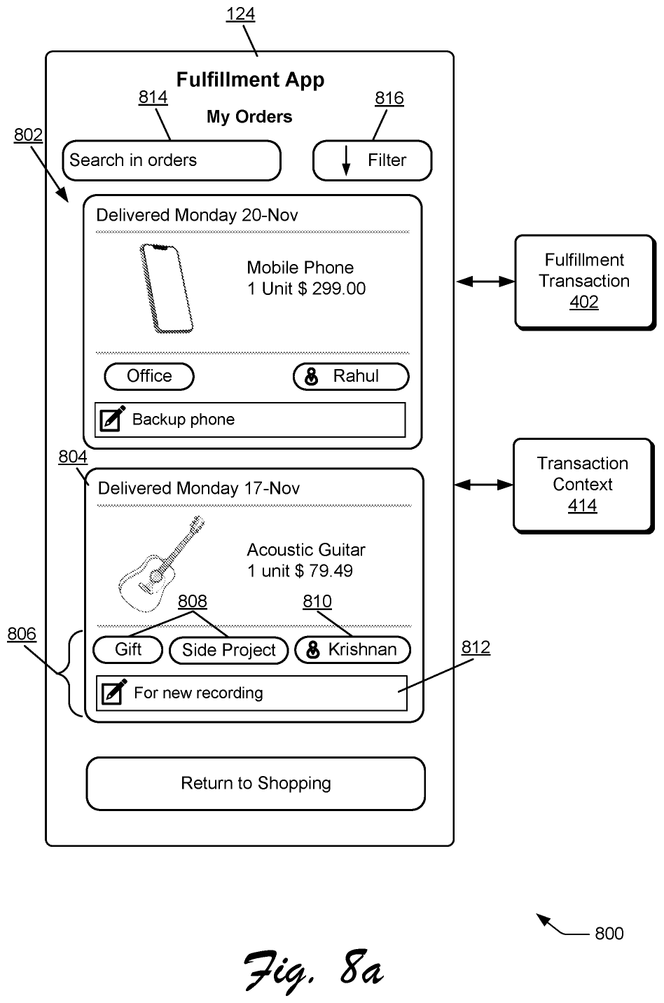

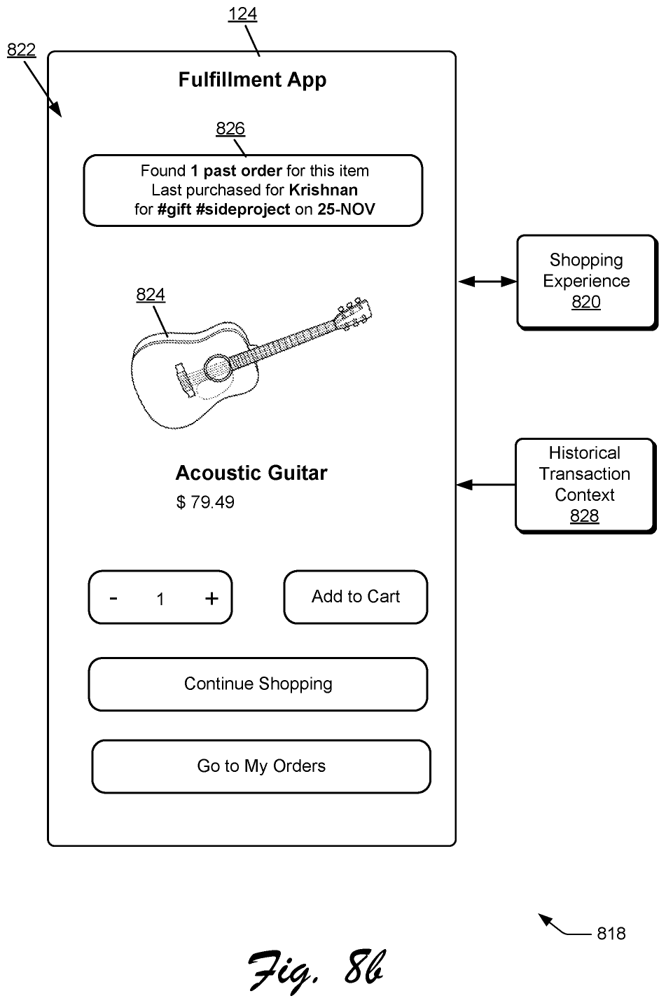

FIG. 8a depicts a scenario 800 including an example implementation of the fulfillment GUI 124 in accordance with one or more implementations. In the scenario 800 the fulfillment GUI 124 includes a transaction history region 802 that presents information about past fulfillment transactions for the user 110. For instance, the transaction history region 802 includes a transaction record 804 for the fulfillment transaction 402. The transaction record 804, for instance, includes various details about the fulfillment transaction 402 such as an item purchased, delivery status, purchase amount, etc.

Further, the transaction record 804 includes a transaction context region 806 that indicates different aspects of the transaction context 414. For instance, the transaction context region 806 includes purpose indicia 808 that identify a user-specified purpose for the fulfillment transaction 402, such as based on input provided to the purpose menu 502 in FIG. 5. Further, the transaction context region 806 includes a recipient indicator 810 that identifies a user-specified intended recipient associated with the fulfillment transaction 402, such as specified via user input to the recipient menu 602 in FIG. 6. Still further, the transaction context region 806 includes a notes region 812 that includes user-specified notes regarding the fulfillment transaction 402, such as specified via user input to the notes field 702 in FIG. 7. Thus, the transaction context region 806 can present a variety of different user-defined context attributes for fulfillment transactions.

In this particular example the fulfillment GUI 124 also includes a search field 814 and a filter control 816. The search field 814 enables a user to search transactions based on various search terms and can enable contextual searches based on context-specific terms such as transaction purpose, transaction recipient, transaction notes, etc. The filter control 816 is selectable to present a contextual filtering experience, examples of which are described below.

FIG. 8b depicts a scenario 818 including an example implementation of the fulfillment GUI 124 in accordance with one or more implementations. In the scenario 818 the user 110 interacts with the fulfillment application 112 as part of a shopping experience 820. For instance, as part of the shopping experience 820 the user 110 browses different products offered by the fulfillment service 104. In this particular example the user 110 views a product page 822 for a product 824. Further, the product based on historical transaction context 828 associated with the product 824. The historical transaction context 828, for instance, is based on transaction context data 122 for user transactions 120 from a user account 118 of the user 110.

Further, the historical transaction context field 826 includes information indicating a previous fulfillment transaction in which the user 110 purchased the product 824. The historical transaction context field 826 identifies transaction context for the previous purchase of the product 824, e.g., an identity of a person for whom the product 824 was purchased and purpose information for the purchase. Thus, historical transaction context 828 can identify transaction context for previous fulfillment transactions within the context of a shopping experience 820, e.g., while the user 110 is browsing different products.

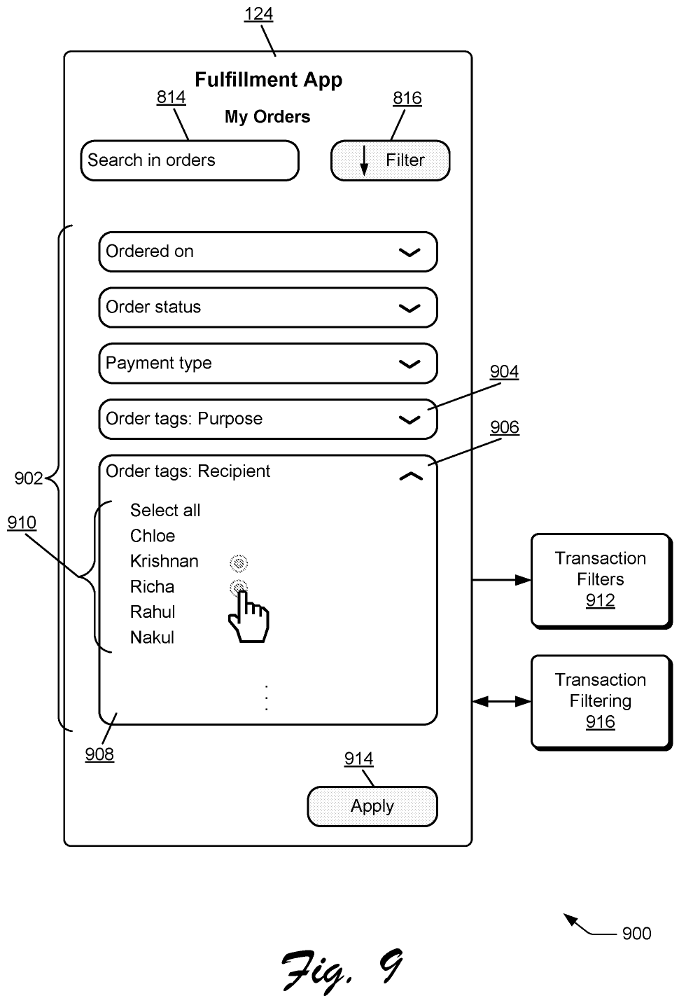

FIG. 9 depicts a scenario 900 including an example implementation of the fulfillment GUI 124 in accordance with one or more implementations. In the scenario 900 the user 110 selects the filter control 816 and the fulfillment application 112 presents fulfillment context filter options 902 for filtering fulfillment transactions. The fulfillment context filter options 902 include a purpose fulfillment context filter option 904 and a recipient fulfillment context filter option 906. The purpose fulfillment context filter option 904 is selectable to enable different transaction purpose filters to be presented for selection, examples of which are described with reference to the purpose options 504 of the purpose menu 502 in FIG. 5. The recipient fulfillment context filter option 906 is selectable to enable different recipient identifiers to be presented for selection and filtering.

In the scenario 900 the user 110 selects the recipient fulfillment context filter option 906 and a recipient filter menu 908 is presented that includes different recipient identifiers 910 that are selectable for transaction filtering. Accordingly, the user 110 selects the recipient identifiers “Krishnan” and “Richa” which are usable by the fulfillment application 112 to generate transaction filters 912. The user 110 then selects an apply control 914 to apply the transaction filters 912. The fulfillment application 112, for instance, transmits the transaction filters 912 to the fulfillment service 104 for performing transaction filtering 916 using the transaction filters 912.

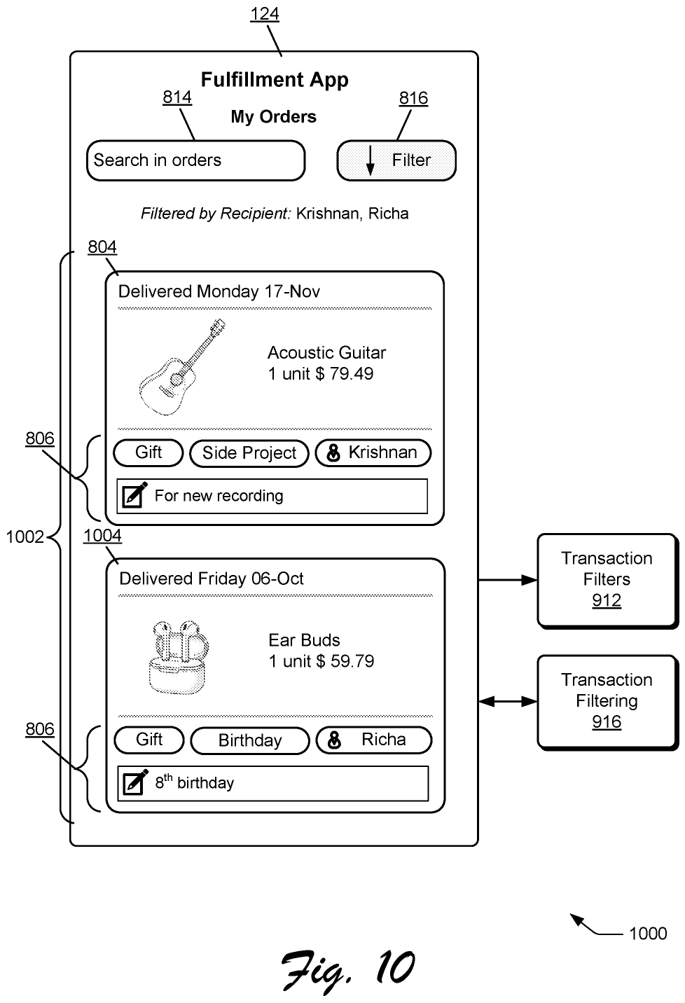

FIG. 10 depicts a scenario 1000 including an example implementation of the fulfillment GUI 124 in accordance with one or more implementations. The scenario 1000, for instance, represents a continuation of the scenario 900. In the scenario 1000 the transaction filtering 916 is applied based at least in part on the transaction filters 912 (e.g., by the fulfillment service 104) and the fulfillment application 112 presents filtered transactions 1002 within the fulfillment GUI 124. The filtered transactions 1002 include the transaction record 804 introduced above in FIG. 8, and a transaction record 1004. The transaction record 804 matches the “Krishnan” recipient filtering criteria of the transaction filters 912 and the transaction record 1004 corresponds to the “Richa” recipient filtering criteria of the transaction filters 912. As illustrated the transaction records 804, 1004 include different examples of transaction context indicia for indicating transaction context for respective fulfillment transactions.

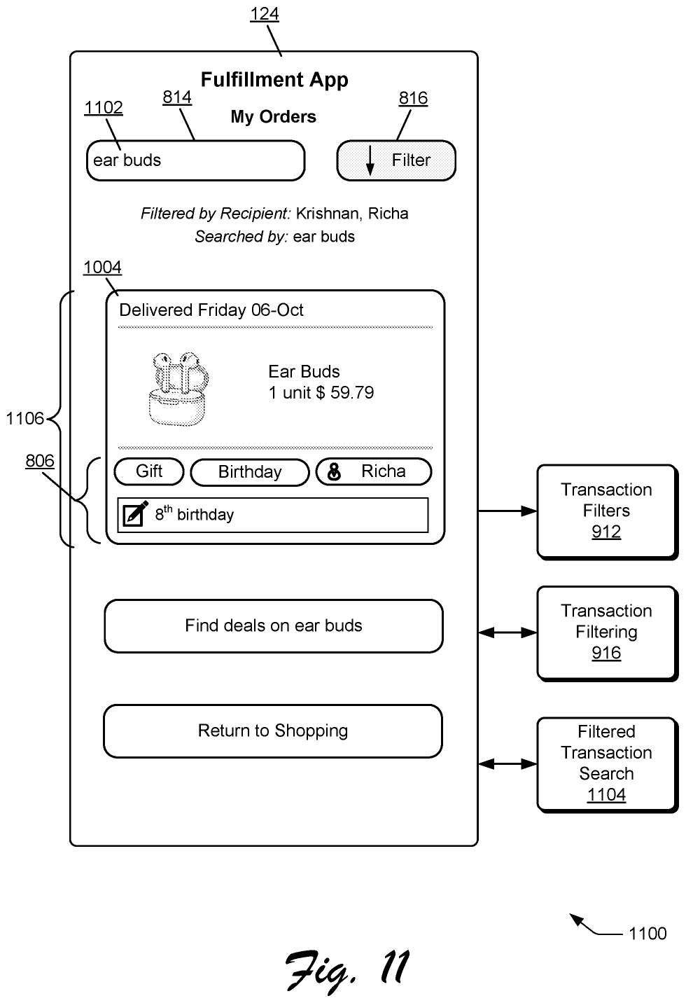

FIG. 11 depicts a scenario 1100 including an example implementation of the fulfillment GUI 124 in accordance with one or more implementations. The scenario 1100, for instance, represents a continuation of the scenario 1000. In the scenario 1100 the user 110 inputs a search term 1102 (“ear buds”) into the search field 814 which causes a filtered transaction search 1104 to be performed on the filtered transactions 1002. The filtered transaction search 1104, for instance, returns a filtered search result 1106 that corresponds to both the transaction filters 912 and the search term 1102. The filtered search result 1106 includes the transaction record 1004 with a corresponding transaction context region 806. Thus, transaction filters and search terms can be used individually and/or in combination to locate fulfillment transactions that correspond to a variety of different fulfillment transaction contexts.

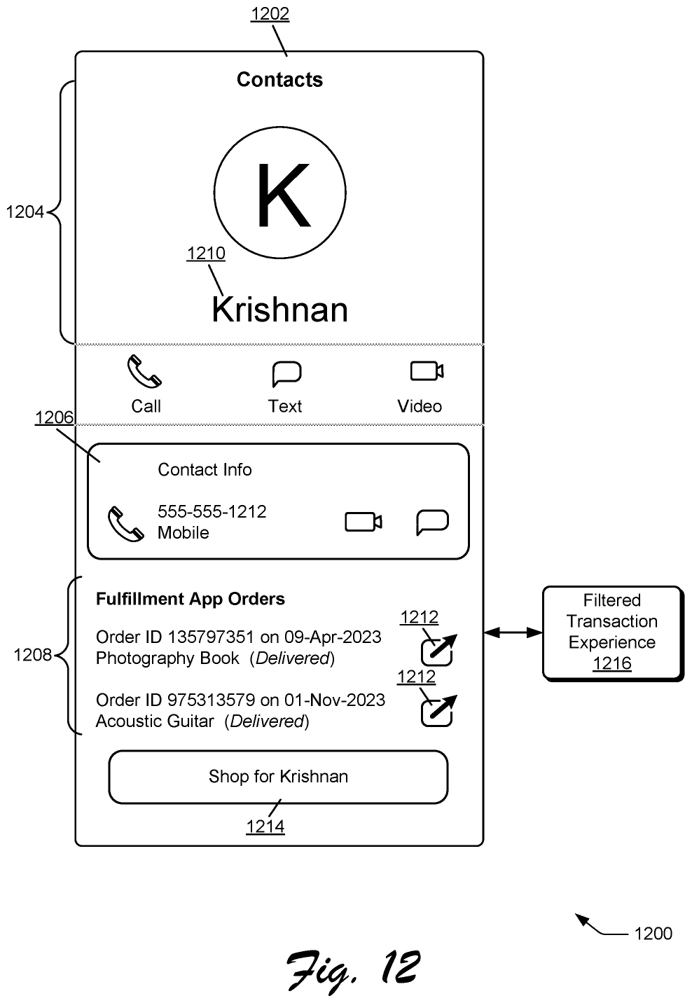

FIG. 12 depicts a scenario 1200 including a contacts GUI 1202 in accordance with one or more implementations. The contacts GUI 1202, for instance, is presented by a service and/or application that manages user contacts, such as for the user 110. The contacts GUI 1202 includes a contact identifier region 1204, a contact information region 1206, and a fulfillment history region 1208. The contact identifier region 1204 includes identifying information for a contact 1210 and the contact information region 1206 includes contact information such as a contact phone number and selectable options for contacting the contact 1210, such as via a phone call, a video call, a text message, etc.

The fulfillment history region 1208 includes information describing past fulfillment transactions associated with the contact 1210, such as implemented via the fulfillment application 112. For instance, the fulfillment history region 1208 lists different fulfillment transactions for which the user 110 indicated the contact as a recipient associated with the fulfillment transactions. Each fulfillment transaction identified in the fulfillment history region 1208 includes a more information control 1212 that is selectable to view additional information about a respective fulfillment transaction.

The contacts GUI 1202 also includes a transaction control 1214 that is selectable to initiate a transaction experience associated with the contact 1210. For instance, selection of the transaction control 1214 launches the fulfillment application 112 and the fulfillment GUI 124 on the client device 102. Further, the fulfillment application 112 can provide a filtered transaction experience 1216 that filters various transaction parameters based on the contact 1210. For instance, the contact 1210 can be used as a filtering criterion for filtering out (e.g., removing) transaction recommendations based on previous fulfillment transactions, e.g., as identified in the fulfillment history region 1208. Alternatively or additionally the filtered transaction experience 1216 can include transaction recommendations that correspond to known preferences for the contact 1210, such as based on a “wish list” created by and/or associated with the contact 1210.

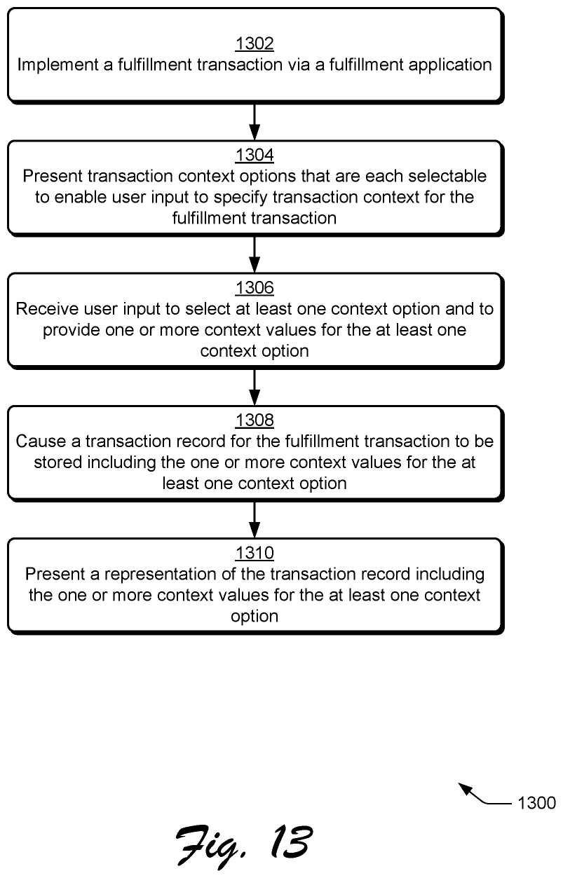

FIG. 13 illustrates a flow chart depicting an example method 1300 for context for fulfillment transactions in accordance with one or more implementations. Operations of the method 1300, for instance, may be performed in the context of the environment 100, such as by the client device 102.

At 1302 a fulfillment transaction is implemented via a fulfillment application. At 1304 transaction context options are presented that are each selectable to enable user input to specify transaction context for the fulfillment transaction. At 1306 user input is received to select at least one context option and to provide one or more context values for the at least one context option. At 1308 a transaction record for the fulfillment transaction is caused to be stored including the one or more context values for the at least one context option. At 1310 a representation of the transaction record is presented including the one or more context values for the at least one context option.

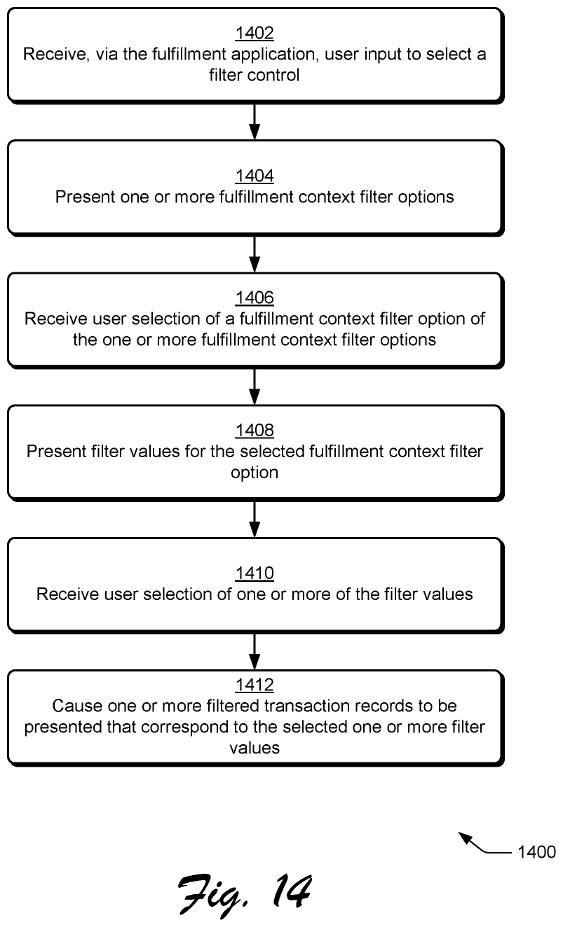

FIG. 14 illustrates a flow chart depicting an example method 1400 for context for fulfillment transactions in accordance with one or more implementations. Operations of the method 1400, for instance, may be performed in the context of the environment 100, such as by the client device 102.

At 1402 user input to select a filter control is received via the fulfillment application. At 1404 one or more fulfillment context filter options are presented. At 1406 user selection of a fulfillment context filter option of the one or more fulfillment context filter options is received. At 1408 filter values for the selected fulfillment context filter option are presented. At 1410 user selection of one or more of the filter values is received. At 1412 one or more filtered transaction records are caused to be presented that correspond to the selected one or more filter values.

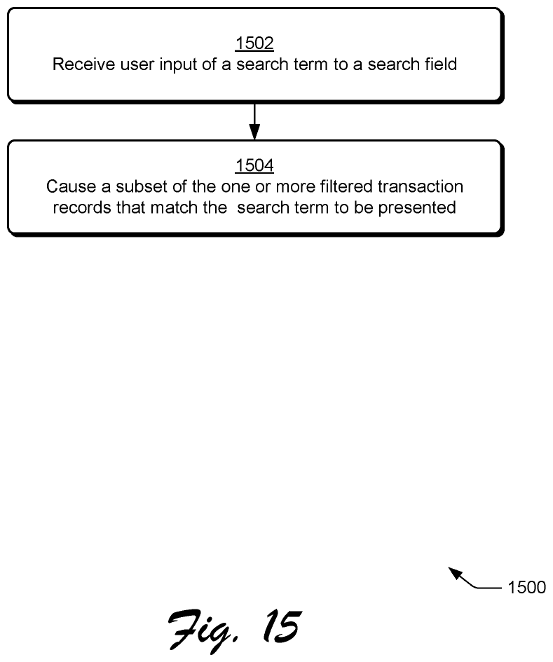

FIG. 15 illustrates a flow chart depicting an example method 1500 for context for fulfillment transactions in accordance with one or more implementations. Operations of the method 1500, for instance, may be performed in the context of the environment 100, such as by the client device 102. At 1502 a data transaction user input of a search term to a search field is received. At 1504 a subset of the one or more filtered transaction records that match the search term is caused to be presented.

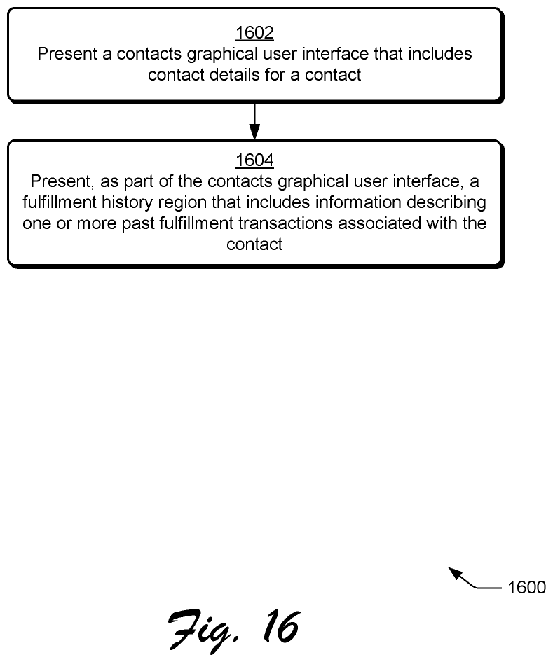

FIG. 16 illustrates a flow chart depicting an example method 1600 for context for fulfillment transactions in accordance with one or more implementations. Operations of the method 1600, for instance, may be performed in the context of the environment 100, such as by the client device 102. At 1602 a contacts graphical user interface is presented that includes contact details for a contact. At 1604, as part of the contacts graphical user interface, a fulfillment history region is presented that includes information describing one or more past fulfillment transactions associated with the contact.

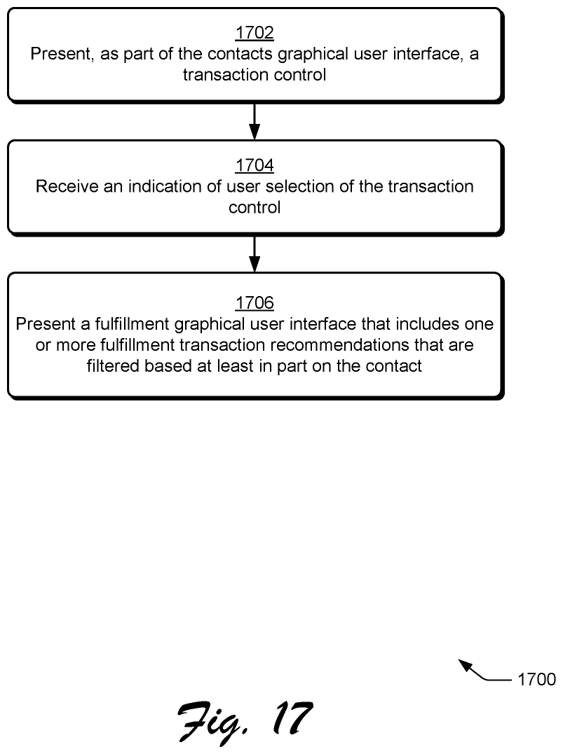

FIG. 17 illustrates a flow chart depicting an example method 1700 for context for fulfillment transactions in accordance with one or more implementations. Operations of the method 1700, for instance, may be performed in the context of the environment 100, such as by the client device 102. At 1702, as part of the contacts graphical user interface, a transaction control is presented. At 1704 an indication of user selection of the transaction control is received. At 1706 a fulfillment graphical user interface is caused to be presented that includes one or more fulfillment transaction recommendations that are filtered based at least in part on the contact.

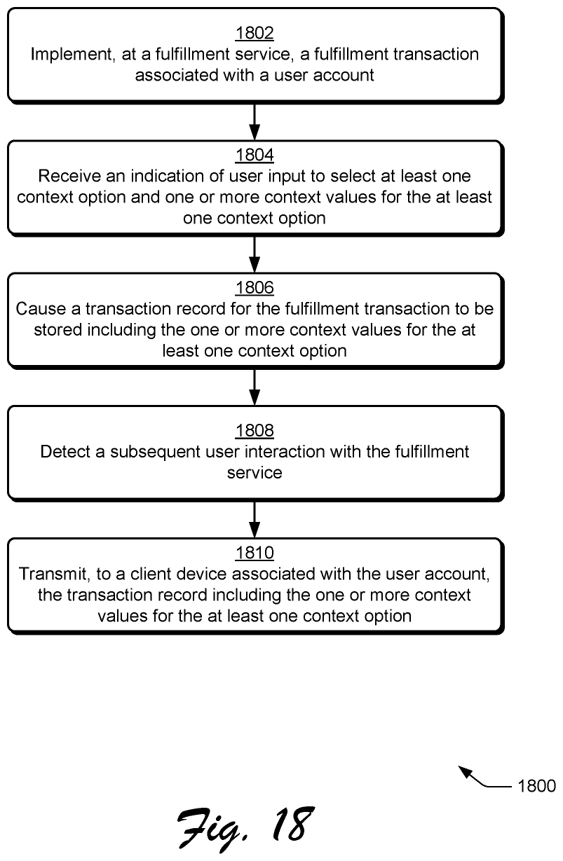

FIG. 18 illustrates a flow chart depicting an example method 1800 for context for fulfillment transactions in accordance with one or more implementations. Operations of the method 1800, for instance, may be performed in the context of the environment 100, such as by the fulfillment service 104.

At 1802 a fulfillment transaction associated with a user account is implemented at a fulfillment service. At 1804 an indication of user input is received to select at least one context option and one or more context values for the at least one context option. At 1806 a transaction record for the fulfillment transaction is caused to be stored including the one or more context values for the at least one context option. At 1808 a subsequent user interaction with the fulfillment service is detected. At 1810 the transaction record including the one or more context values for the at least one context option is transmitted to a client device associated with the user account.

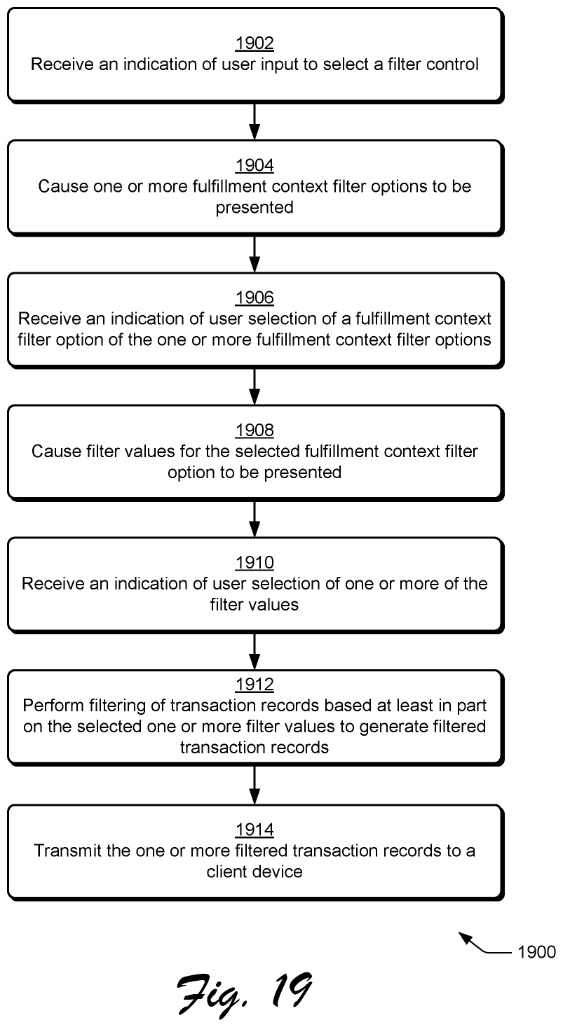

FIG. 19 illustrates a flow chart depicting an example method 1900 for context for fulfillment transactions in accordance with one or more implementations. Operations of the method 1900, for instance, may be performed in the context of the environment 100, such as by the fulfillment service 104.

At 1902 an indication of user input to select a filter control is received. At 1904 one or more fulfillment context filter options are caused to be presented. At 1906 an indication of user selection of a fulfillment context filter option of the one or more fulfillment context filter options is received. At 1908 filter values for the selected fulfillment context filter option are caused to be presented. At 1910 an indication of user selection of one or more of the filter values is received. At 1912 filtering of transaction records based at least in part on the selected one or more filter values is performed to generate filtered transaction records. At 1914 the one or more filtered transaction records are transmitted to a client device.

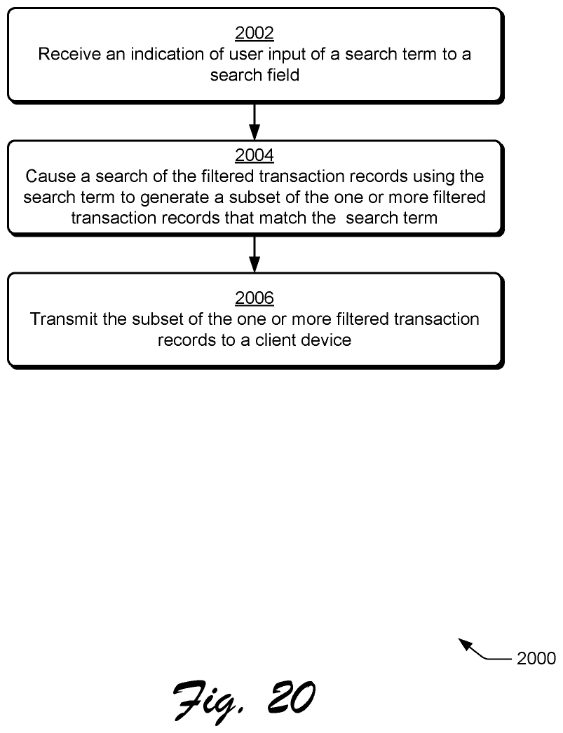

FIG. 20 illustrates a flow chart depicting an example method 2000 for context for fulfillment transactions in accordance with one or more implementations. Operations of the method 2000, for instance, may be performed in the context of the environment 100, such as by the fulfillment service 104. At 2002 an indication of user input of a search term to a search field is received. At 2004 a search of the filtered transaction records using the search term is caused to generate a subset of the one or more filtered transaction records that match the search term. At 2006 the subset of the one or more filtered transaction records is transmitted to a client device.

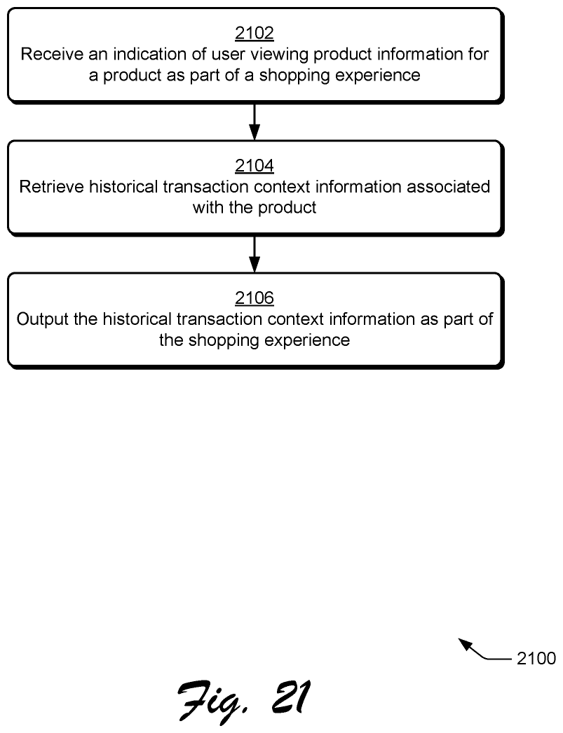

FIG. 21 illustrates a flow chart depicting an example method 2100 for context for fulfillment transactions in accordance with one or more implementations. Operations of the method 2100, for instance, may be performed in the context of the environment 100, such as by the fulfillment service 104. At 2102 an indication of user viewing product information for a product as part of a shopping experience is received. At 2104 historical transaction context information associated with the product is retrieved. At 2106 the historical transaction context information is output as part of the shopping experience.

The example methods described above may be performed in various ways, such as for implementing various aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 22 illustrates various components of an example device 2200 in which aspects of context for fulfillment transactions can be implemented. The example device 2200 can be implemented as any of the devices described with reference to the previous FIGS. 1-21, such as any type of mobile device, mobile phone, mobile device, wearable device, tablet, computing, communication, entertainment, gaming, media playback, and/or other type of electronic device. For example, the client device 102, the fulfillment service 104, and/or the transaction service 106 as shown and described with reference to FIGS. 1-21 may be implemented as the example device 2200.

The device 2200 includes communication transceivers 2202 that enable wired and/or wireless communication of device data 2204 with other devices. The device data 2204 can include any of device identifying data, device location data, wireless connectivity data, and wireless protocol data. Additionally, the device data 2204 can include any type of audio, video, and/or image data. Example communication transceivers 2202 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 2200 may also include one or more data input ports 2206 via which any type of data, media content, and/or inputs can be received, such as user selectable-inputs to the device, messages, music, television content, recorded content, and any other type of audio, video, and/or image data received from any content and/or data source. The data input ports may include USB (Universal Serial Bus) ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 2200 includes a processing system 2208 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are identified at 2210. The device 2200 may further include any type of a system bus or other data and command transfer system that couples the various components within the device. A system bus can include any one or combination of different bus structures and architectures, as well as control and data lines.

The device 2200 also includes computer-readable storage memory 2212 (e.g., memory devices) that enable data storage, such as data storage devices that can be accessed by a computing device, and that provide persistent storage of data and executable instructions (e.g., software applications, programs, functions, and the like). Examples of the computer-readable storage memory 2212 include volatile memory and non-volatile memory, fixed and removable media devices, and any suitable memory device or electronic data storage that maintains data for computing device access. The computer-readable storage memory can include various implementations of random access memory (RAM), read-only-memory (ROM), flash memory, and other types of storage media in various memory device configurations. The device 2200 may also include a mass storage media device.

The computer-readable storage memory 2212 provides data storage mechanisms to store the device data 2204, other types of information and/or data, and various device applications 2214 (e.g., software applications). For example, an operating system 2216 can be maintained as software instructions with a memory device and executed by the processing system 2208. The device applications may also include a device manager, such as any form of a control application, software application, signal-processing and control module, code that is native to a particular device, a hardware abstraction layer for a particular device, and so on. Computer-readable storage memory 2212 represents media and/or devices that enable persistent and/or non-transitory storage of information in contrast to mere signal transmission, carrier waves, or signals per se. Computer-readable storage memory 2212 do not include signals per se or transitory signals.

In this example, the device 2200 includes a fulfillment service 2218 and a fulfillment application 2220 that can implement aspects of context for fulfillment transactions and may be implemented with hardware components and/or in software as one of the device applications 2214. For example, the fulfillment service 2218 can implement the fulfillment service 104 and the fulfillment application 2220 can implement the fulfillment application 112. In implementations, the fulfillment service 2218 and/or the fulfillment application 2220 may include independent processing, memory, and logic components as a computing and/or electronic device integrated with the device 2200. In certain embodiments, the fulfillment service 104 or its constituent components may be instantiated externally to the device 2200, such as on a server.

In this example, the example device 2200 also includes a camera 2222 and motion sensors 2224, such as may be implemented in an inertial measurement unit (IMU). The motion sensors 2224 can be implemented with various sensors, such as a gyroscope, an accelerometer, and/or other types of motion sensors to sense motion of the device. The various motion sensors 2224 may also be implemented as components of an inertial measurement unit in the device.

The device 2200 also includes a wireless module 2226, which is representative of functionality to perform various wireless communication tasks. The device 2200 can also include one or more power sources 2228, such as when the device is implemented as a mobile device. The power sources 2228 may include a charging and/or power system, and can be implemented as a flexible strip battery, a rechargeable battery, a charged super-capacitor, and/or any other type of active or passive power source.

The device 2200 also includes an audio and/or video processing system 2230 that generates audio data for an audio system 2232 and/or generates display data for a display system 2234. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 2236. In implementations, the audio system and/or the display system are integrated components of the example device. Alternatively, the audio system and/or the display system are external, peripheral components to the example device.

Although implementations of feedback and context for fulfillment transactions have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one processor; and one or more modules executable by the at least one processor to: implement a fulfillment transaction via a fulfillment application; present transaction context options that are each selectable to enable user input to specify transaction context for the fulfillment transaction; receive user input to select at least one context option and to provide one or more context values for the at least one context option; cause a transaction record for the fulfillment transaction to be stored including the one or more context values for the at least one context option; and present a representation of the transaction record including the one or more context values for the at least one context option.

In some aspects, the techniques described herein relate to a client device, wherein the fulfillment transaction includes a product purchase via the fulfillment application.

In some aspects, the techniques described herein relate to a client device, wherein the context options include one or more of a transaction purpose option, a recipient option, or a transaction notes option.

In some aspects, the techniques described herein relate to a client device, wherein the at least one context option includes a purpose option, and wherein the one or more modules are executable by the at least one processor to present a purpose menu that includes multiple different selectable purpose options describing different selectable purposes for the fulfillment transaction, wherein the user input to provide the one or more context values includes a user selection of at least one of the purpose options.

In some aspects, the techniques described herein relate to a client device, wherein the at least one context option includes a recipient option, and wherein the one or more modules are executable by the at least one processor to present a recipient menu that includes multiple different selectable recipient identifiers, wherein the user input to provide the one or more context values includes a user selection of at least one of the recipient identifiers.

In some aspects, the techniques described herein relate to a client device, wherein the at least one context option includes a transaction notes option, and wherein the one or more modules are executable by the at least one processor to present a notes field, and wherein the user input to provide the one or more context values includes user input to the notes field to specify transaction notes for the fulfillment transaction.

In some aspects, the techniques described herein relate to a client device, wherein the context options include two or more of a transaction purpose option, a recipient option, or a transaction notes option, and wherein the one or more modules are executable by the at least one processor to present the one or more context values in the representation of the transaction record as one or more context values for the one or more of the transaction purpose option, the recipient option, or the transaction notes option.

In some aspects, the techniques described herein relate to a client device, wherein the one or more modules are executable by the at least one processor to: receive, via the fulfillment application, user input to select a filter control; present one or more fulfillment context filter options; receive user selection of a fulfillment context filter option of the one or more filter options; present filter values for the selected fulfillment context filter option; receive user selection of one or more of the fulfillment context filter values; and cause one or more filtered transaction records to be presented that correspond to the selected one or more fulfillment context filter values.

In some aspects, the techniques described herein relate to a client device, wherein the one or more modules are executable by the at least one processor to: receive user input of a search term to a search field; and cause a subset of the one or more filtered transaction records that match the search term to be presented.

In some aspects, the techniques described herein relate to a client device, wherein the one or more modules are executable by the at least one processor to: present a contacts graphical user interface that includes contact details for a contact; and present, as part of the contacts graphical user interface, a fulfillment history region that includes information describing one or more past fulfillment transactions associated with the contact.

In some aspects, the techniques described herein relate to a client device, wherein the one or more modules are executable by the at least one processor to: present, as part of the contacts graphical user interface, a transaction control; receive an indication of user selection of the transaction control; and present a fulfillment graphical user interface to be presented that includes one or more fulfillment transaction recommendations that are filtered based at least in part on the contact.

In some aspects, the techniques described herein relate to a system including: at least one memory; and at least one processor coupled to the at least one memory and configured to cause the system to: implement, at a fulfillment service, a fulfillment transaction associated with a user account; receive an indication of user input to select at least one context option and one or more context values for the at least one context option; cause a transaction record for the fulfillment transaction to be stored including the one or more context values for the at least one context option; detect a subsequent user interaction with the fulfillment service; and transmit, to a client device associated with the user account, the transaction record including the one or more context values for the at least one context option.

In some aspects, the techniques described herein relate to a system, wherein the fulfillment transaction includes a product purchase via the fulfillment service.

In some aspects, the techniques described herein relate to a system, wherein the at least one context option includes a recipient option, and wherein the at least one processor is configured to cause the system to cause a recipient menu to be presented that includes multiple different selectable recipient identifiers, wherein the indication of the user input to includes an indication of a user selection of at least one of the recipient identifiers.

In some aspects, the techniques described herein relate to a system, wherein the at least one context option includes a transaction notes option, and wherein the at least one processor is configured to cause the system to cause a notes field to be presented, and wherein the indication of the user input includes an indication of user input to the notes field to specify transaction notes for the fulfillment transaction.

In some aspects, the techniques described herein relate to a system, wherein the context options include two or more of a transaction purpose option, a recipient option, or a transaction notes option, and wherein the at least one processor is configured to cause the system to store the transaction record including the one or more context values for the one or more of the transaction purpose option, the recipient option, or the transaction notes option.

In some aspects, the techniques described herein relate to a system, wherein the at least one processor is configured to cause the system to: receive an indication of user input to select a filter control; cause one or more fulfillment context filter options associated with fulfillment context to be presented; receive an indication of user selection of a fulfillment context filter option of the one or more fulfillment context filter options associated with fulfillment context; cause filter values for the selected fulfillment context filter option associated with fulfillment context to be presented; receive an indication of user selection of one or more of the values for the fulfillment context filter option associated with fulfillment context; perform filtering of transaction records based at least in part on the selected one or more filter values to generate filtered transaction records; and transmit the one or more filtered transaction records to a client device.

In some aspects, the techniques described herein relate to a system, wherein: receive an indication of user input of a search term to a search field; cause a search of the filtered transaction records using the search term to generate a subset of the one or more filtered transaction records that match the search term; and transmit the subset of the one or more filtered transaction records to a client device.

In some aspects, the techniques described herein relate to a method including: implementing a fulfillment transaction via a fulfillment application; presenting transaction context options that are each selectable to enable user input to specify transaction context for the fulfillment transaction; receiving user input to select at least one context option and to provide one or more context values for the at least one context option; causing a transaction record for the fulfillment transaction to be stored including the one or more context values for the at least one context option; and presenting a representation of the transaction record including the one or more context values for the at least one context option.

In some aspects, the techniques described herein relate to a method, further including: receiving an indication of user input to select a filter control associated with fulfillment context; causing one or more fulfillment context filter options associated with fulfillment context to be presented; receiving an indication of user selection of a fulfillment context filter option of the one or more fulfillment context filter options associated with fulfillment context; causing filter values for the selected fulfillment context filter option associated with fulfillment context to be presented; receiving an indication of user selection of one or more of the filter values; performing filtering of transaction records based at least in part on the selected one or more filter values to generate filtered transaction records; and transmitting the one or more filtered transaction records to a client device.

1. A client device comprising:
at least one processor; and
one or more modules executable by the at least one processor to:
implement a fulfillment transaction via a fulfillment application;
present transaction context options that are each selectable to enable user input to specify transaction context for the fulfillment transaction;
receive user input to select at least one context option and to provide one or more context values for the at least one context option;
cause a transaction record for the fulfillment transaction to be stored including the one or more context values for the at least one context option; and
present a representation of the transaction record including the one or more context values for the at least one context option.

2. The client device of claim 1, wherein the fulfillment transaction comprises a product purchase via the fulfillment application.

3. The client device of claim 1, wherein the context options comprise one or more of a transaction purpose option, a recipient option, or a transaction notes option.

4. The client device of claim 1, wherein the at least one context option comprises a purpose option, and wherein the one or more modules are executable by the at least one processor to present a purpose menu that includes multiple different selectable purpose options describing different selectable purposes for the fulfillment transaction, wherein the user input to provide the one or more context values comprises a user selection of at least one of the purpose options.

5. The client device of claim 1, wherein the at least one context option comprises a recipient option, and wherein the one or more modules are executable by the at least one processor to present a recipient menu that includes multiple different selectable recipient identifiers, wherein the user input to provide the one or more context values comprises a user selection of at least one of the recipient identifiers.

6. The client device of claim 1, wherein the at least one context option comprises a transaction notes option, and wherein the one or more modules are executable by the at least one processor to present a notes field, and wherein the user input to provide the one or more context values comprises user input to the notes field to specify transaction notes for the fulfillment transaction.

7. The client device of claim 1, wherein the context options comprise two or more of a transaction purpose option, a recipient option, or a transaction notes option, and wherein the one or more modules are executable by the at least one processor to present the one or more context values in the representation of the transaction record as one or more context values for the one or more of the transaction purpose option, the recipient option, or the transaction notes option.

8. The client device of claim 1, wherein the one or more modules are executable by the at least one processor to:
receive, via the fulfillment application, user input to select a filter control;
present one or more fulfillment context filter options;
receive user selection of a fulfillment context filter option of the one or more filter options;
present filter values for the selected fulfillment context filter option;
receive user selection of one or more of the fulfillment context filter values; and
cause one or more filtered transaction records to be presented that correspond to the selected one or more fulfillment context filter values.

9. The client device of claim 8, wherein the one or more modules are executable by the at least one processor to:
receive user input of a search term to a search field; and
cause a subset of the one or more filtered transaction records that match the search term to be presented.

10. The client device of claim 1, wherein the one or more modules are executable by the at least one processor to:
present a contacts graphical user interface that includes contact details for a contact; and
present, as part of the contacts graphical user interface, a fulfillment history region that includes information describing one or more past fulfillment transactions associated with the contact.

11. The client device of claim 10, wherein the one or more modules are executable by the at least one processor to:
present, as part of the contacts graphical user interface, a transaction control;
receive an indication of user selection of the transaction control; and
present a fulfillment graphical user interface to be presented that includes one or more fulfillment transaction recommendations that are filtered based at least in part on the contact.

12. A system comprising:
at least one memory; and
at least one processor coupled to the at least one memory and configured to cause the system to:
implement, at a fulfillment service, a fulfillment transaction associated with a user account;
receive an indication of user input to select at least one context option and one or more context values for the at least one context option;
cause a transaction record for the fulfillment transaction to be stored including the one or more context values for the at least one context option;
detect a subsequent user interaction with the fulfillment service; and
transmit, to a client device associated with the user account, the transaction record including the one or more context values for the at least one context option.

13. The system of claim 12, wherein the fulfillment transaction comprises a product purchase via the fulfillment service.

14. The system of claim 12, wherein the at least one context option comprises a recipient option, and wherein the at least one processor is configured to cause the system to cause a recipient menu to be presented that includes multiple different selectable recipient identifiers, wherein the indication of the user input to comprises an indication of a user selection of at least one of the recipient identifiers.

15. The system of claim 12, wherein the at least one context option comprises a transaction notes option, and wherein the at least one processor is configured to cause the system to cause a notes field to be presented, and wherein the indication of the user input comprises an indication of user input to the notes field to specify transaction notes for the fulfillment transaction.

16. The system of claim 12, wherein the context options comprise two or more of a transaction purpose option, a recipient option, or a transaction notes option, and wherein the at least one processor is configured to cause the system to store the transaction record including the one or more context values for the one or more of the transaction purpose option, the recipient option, or the transaction notes option.

17. The system of claim 12, wherein the at least one processor is configured to cause the system to:
receive an indication of user input to select a filter control;
cause one or more fulfillment context filter options associated with fulfillment context to be presented;
receive an indication of user selection of a fulfillment context filter option of the one or more fulfillment context filter options associated with fulfillment context;
cause filter values for the selected fulfillment context filter option associated with fulfillment context to be presented;
receive an indication of user selection of one or more of the values for the fulfillment context filter option associated with fulfillment context;
perform filtering of transaction records based at least in part on the selected one or more filter values to generate filtered transaction records; and
transmit the one or more filtered transaction records to a client device.

18. The system of claim 17, wherein:
receive an indication of user input of a search term to a search field;
cause a search of the filtered transaction records using the search term to generate a subset of the one or more filtered transaction records that match the search term; and
transmit the subset of the one or more filtered transaction records to a client device.

19. A method comprising:
implementing a fulfillment transaction via a fulfillment application;
presenting transaction context options that are each selectable to enable user input to specify transaction context for the fulfillment transaction;
receiving user input to select at least one context option and to provide one or more context values for the at least one context option;
causing a transaction record for the fulfillment transaction to be stored including the one or more context values for the at least one context option; and
presenting a representation of the transaction record including the one or more context values for the at least one context option.

20. The method of claim 19, further comprising:
receiving an indication of user input to select a filter control associated with fulfillment context;
causing one or more fulfillment context filter options associated with fulfillment context to be presented;
receiving an indication of user selection of a fulfillment context filter option of the one or more fulfillment context filter options associated with fulfillment context;
causing filter values for the selected fulfillment context filter option associated with fulfillment context to be presented;
receiving an indication of user selection of one or more of the filter values;
performing filtering of transaction records based at least in part on the selected one or more filter values to generate filtered transaction records; and
transmitting the one or more filtered transaction records to a client device.
